(19) United States
(12) Patent Application Publication
(10) Pub. No.: US 2024/0148195 A1
(43) Pub. Date: May 9, 2024

(54) Utensil Holding Device

(71) Applicant: Bernard Knight Sr., SR., Sanford, FL (US)

(72) Inventor: Bernard Knight Sr., SR., Sanford, FL (US)

(21) Appl. No.: 18/496,842

(22) Filed: Oct. 28, 2023

Related U.S. Application Data
(60) Provisional application No. 63/422,960, filed on Nov. 5, 2022.

(51) Int. Cl. A47J 47/16

(52) U.S. Cl. CPC A47J 47/16

(57) ABSTRACT

A Serving Utensil Holder made of materials approved for food service. The holder has a flat base. The base is connected to stationary or adjustable shaft with top end fitted with a utensil holder attachment to hold various types, and sizes of food serving utensils. Serving utensil holder flat base includes a vertical flange around the top perimeter for catching and keeping food droppings and liquids from hanging serving utensils and keeping the drippings on top of the base surface preventing them from spilling onto buffet, tables, or counter-tops.

Attachments can be permanently made on shaft, or fixed with fasteners allowing other attachments to be used on the same utensil holder.

### FIELD OF THE INVENTION

The present invention relates to cooking and food serving utensils and, more particularly, a stand having a flat base that holds spoons, ladles, tongs, and other various cooking and food serving utensils when not in use to keep them from contamination from being left on counters, stove tops or in serving pans with the food.

### BACKGROUND OF THE INVENTION

Spoons, ladles, tongs, and other serving utensils used in the commercial food service and home kitchens are either left in the food pan or on counters which in both cases increase the chances of the utensil being contaminated and thus contaminating the food. Some in the food service industry have made attempts to elevate this problem by creating serving spoon rests, which are small bowls or trays that hold the serving utensil keeping them from being left in cooking containers, on stoves, on food servers, counter-tops or tables when the utensil is not being used.

There are various designs of spoon holders or spoon rests available on the market, such as those shaped like bowls that cradles spoons and other food serving utensils when they are not in use. There are also spoon holders on stands enabling the serving utensils to freely hang when they are not in use.

These products may work in some home and commercial settings, but some utensil holders and spoon rests take up space and are often in the way. There are some utensil holders and spoon rests that don't easily allow serving utensils to be placed and removed from them when needed. Because of a poor design, some utensil holders allow food or food dropping from the food serving utensils to fall on the stove, counter-tops or tables.

It is therefore an object of the invention to provide a holder for food serving utensils that doesn't require a lot of space. It is another object of the invention to keep food serving utensils from contamination through being left on counter-tops, tables, stoves or other surfaces. It is another object of the invention to provide a holding place for food serving utensils that allows food serving spoons and other utensils to be easily placed and removed when needed. It is another object of the invention to provide a food serving utensils holder that has an area that prevents food and food droppings from the serving utensils from falling on counter-tops, tables, stoves, and other surfaces.

### SUMMARY OF INVENTION

In accordance with the present invention, there is provided a Serving Utensil Holder made of stainless steel or any material, metal, plastic, or composite that is approved to be used in the food service industry. The serving utensil holder has a flat base connected to a vertical tubular shaft having a telescoping L-shaped arm that adjust up and down. The L-shaped arm has a connection point at the end to receive removable attachments for hanging various serving utensils. Serving utensil holder base includes a flat portion and vertical flange for keeping food and food droppings from falling from the serving utensils onto stoves, counters, or tables.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a right perspective view of a serving utensil holder with a flat base in accordance with the invention;

FIG. 2 is a right perspective view of a serving utensil holder with a flat base having a vertical flange edge that keeps food and food droppings from falling from the serving utensils onto stoves, counters, or tables. The flat base is connected to a vertical tubular shaft that has a telescoping L-shaped arm. The adjustable arm has a connection point to receive a hook-shaped utensil attachment for holding food serving utensils in accordance with the invention;

FIG. 3 is a right perspective view of a serving utensil holder with a flat base having a vertical flange edge that keeps food and food droppings from falling from the serving utensils onto stoves, counters, or tables. The base is connected to a vertical tubular shaft that has a telescoping L-shaped arm. The adjustable arm has a connection point to receive a hook-shaped attachment for holding food serving utensils in accordance with the invention;

FIG. 4 is a right perspective view of a serving utensil holder with a flat base having a vertical flange edge that keeps food and food droppings from falling from the serving utensils onto stoves, counters, or tables. The base is connected to a vertical tubular shaft that has a telescoping L-shaped arm. The adjustable arm has a connection point to receive a C-shaped prong attachment that is holding a spoon food serving utensil in accordance with the invention;

FIG. 5 is a right view of a serving utensil holder with a flat base having a vertical flange edge that keeps food and food droppings from falling from the serving utensils onto stoves, counters, or tables. The base is connected to a vertical tubular shaft that has a telescoping L-shaped arm. The adjustable arm has a connection point to receive a C-shaped attachment for holding serving utensils in accordance with the invention;

### DESCRIPTION OF THE PREFERRED EMBODIMENT

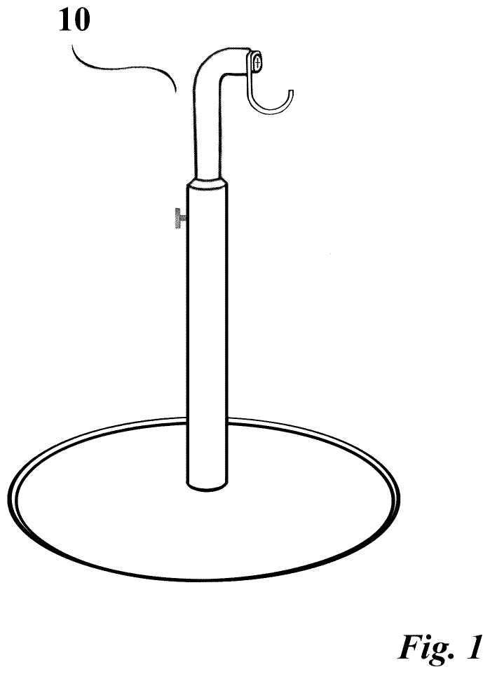

FIG. 1 is a right view of a Serving Utensil Holder 10 in accordance with the invention.

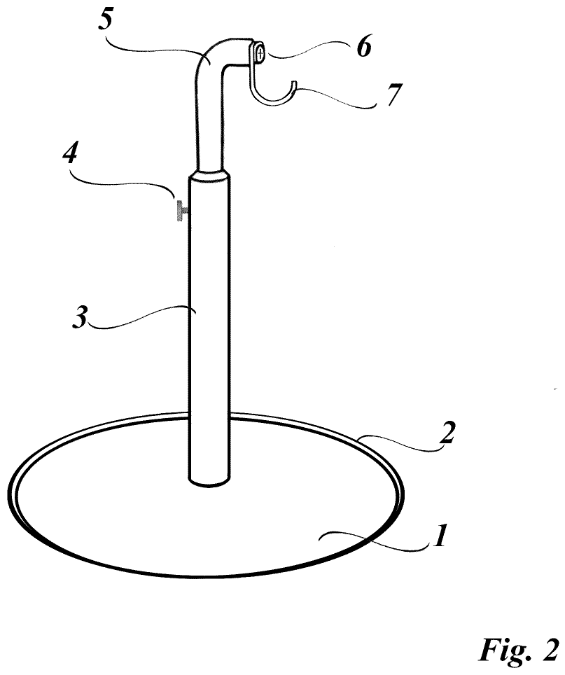

FIG. 2 is a right view of a Serving Utensil Holder 10 in accordance with the invention, showing a flat base 1 having a vertical flange edge 2, for keeping food particles or droppings from the serving utensils on the flat base 1 base of the serving utensil holder 10 and preventing them from spilling onto tables, counter-tops, stoves, and other surfaces. Flat base 1 connects to a vertical tubular shaft 3, telescoping L-shaped arm 5 with thumb screw 4, for adjusting telescoping L-shaped arm 5. A hook-shaped attachment 7, is secured to the telescoping L-shaped arm 5 by a fastener 6.

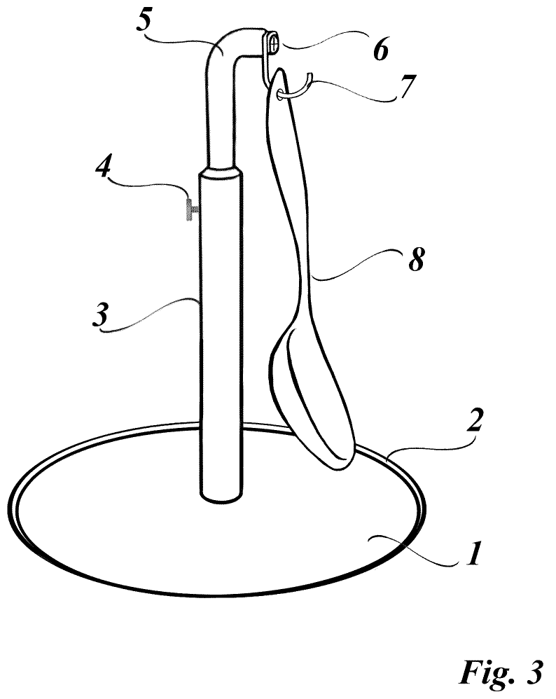

FIG. 3 is a right view of a Serving Utensil Holder 10 in accordance with the invention, showing a flat base 1 having a vertical flange edge 2, for keeping food particles or droppings from the serving utensils on the flat base 1 of the serving utensil holder 10 and preventing them from spilling onto tables, counter-tops, stoves, and other surfaces. Flat base 1 connects to a vertical tubular shaft 3, telescoping L-shaped arm 5 with thumb screw 4, for adjusting telescoping L-shaped arm 5. A hook-shaped attachment 7, is secured to the telescoping L-shaped arm 5 by a fastener 6. The hook shaped attachment 7 is holding a spoon 9.

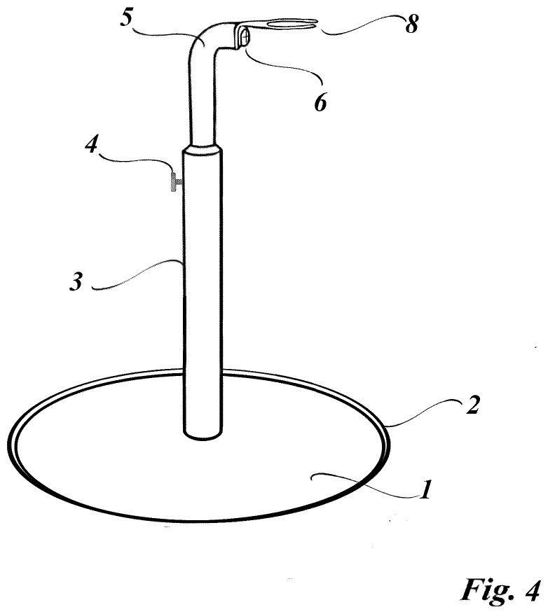

FIG. 4 is a right view of a Serving Utensil Holder 10 in accordance with the invention, showing a flat base 1 having a vertical flange edge 2, for keeping food particles or droppings from the serving utensils on the flat base 1 of the serving utensil holder 10 and preventing them from spilling onto tables, counter-tops, stoves, and other surfaces. Flat base 1 connects to a vertical tubular shaft 3, telescoping L-shaped arm 5 with thumb screw 4, for adjusting telescoping L-shaped arm 5. A C-shaped attachment 8, is secured to the telescoping L-shaped arm 5 by a fastener 6.

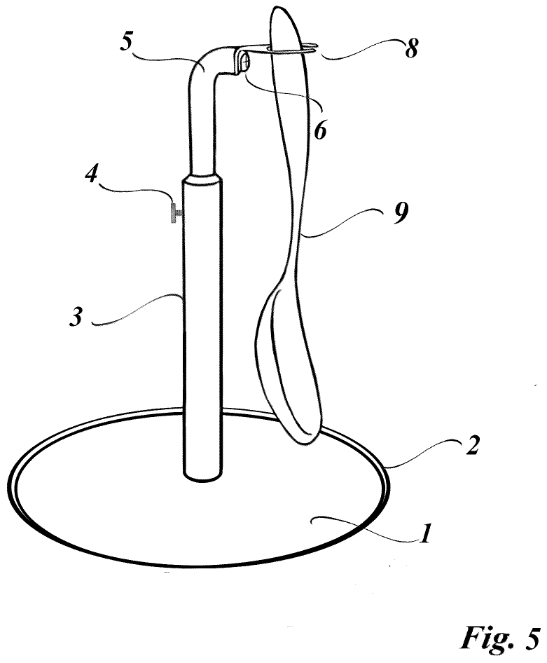

FIG. 5 is a right view of a Serving Utensil Holder 10 in accordance with the invention, showing a flat base 1 having a vertical flange edge 2, for keeping food particles or droppings from the serving utensils on the flat base 1 base of the serving utensil holder 10 and preventing them from spilling onto tables, counter-tops, stoves, and other surfaces. Flat base 1 connects to a vertical tubular shaft 3, telescoping L-shaped arm 5 with thumb screw 4, for adjusting telescoping L-shaped arm 5. A C-shaped attachment 8, is secured to the telescoping L-shaped arm 5 by a fastener 6. The C-shaped attachment 8 is holding a spoon 9.

What is claimed:

1. A serving utensil holder for hanging cooking and food serving utensils comprising:
means for providing a holder for food serving utensils to keep them from contamination by being left in food, on counter-tops, tables, stoves or other surfaces,
means for providing a holder for food serving utensils that allows food serving spoons and other utensils to be easily placed and removed from utensil holder when needed to serve food,
means for providing a holder for food serving utensils with an area that catches food and food droppings from the hanging serving utensils preventing the dripping food or liquids from falling onto counter-tops, tables, stoves, and other surfaces,
means of providing a utensil holder with a flat base for allowing a serving utensil holder to be placed on any flat surfaces including buffets, tables, counter-tops, having a base that includes a vertical flange around the top perimeter for catching and keeping food and liquid droppings from hanging serving utensils from dripping onto buffets, tables, or counter-tops,
means of support including a hollow shaft extending upwardly from a top surface of the base and an L-shaped arm received therein, wherein the L-shaped arm is telescopically adjustable with respect to the hollow shaft to accommodate varying heights of serving utensils hanging therefrom; and a hanging attachment detach-ably connected to an outside end of the L-shaped arm, wherein the hanging attachment is hooked shaped or C-shaped or any other attachments adapted to hang cooking and food serving utensils there from, keeping the cooking and food serving utensils from touching and contaminating surrounding surfaces.

2. A utensil holding device in accordance with claim 1 comprising; a solid hollow shaft extending upwardly from a top surface of the flat base and an L-shaped arm received therein, wherein the L-shaped arm is telescopically adjustable with respect to the hollow shaft to accommodate varying heights of serving utensils hanging therefrom.

3. A utensil holding device in accordance with claim 1 comprising; a hanging attachment detach-ably connected to an outside end of the L-shaped arm, wherein attachments adapted to hang cooking and food serving utensils.

4. A utensil holding device in accordance with claim 1 comprising; a solid shaft extending upwardly from a top surface of the base and an L-shaped arm rigidly attached, to accommodate fixed heights of serving utensils hanging therefrom.

5. A utensil holding device in accordance with claim 1 comprising; a flat base includes a vertical flange around the top perimeter for catching and keeping food droppings and liquids from hanging serving utensils and keeping the drippings on top of the base surface preventing them from spilling onto buffets, tables, counter-tops or other surfaces.

6. A utensil holding device in accordance with claim 1 comprising; a hooked shaped or C-shaped or any other attachments adapted to hang cooking and food serving utensils detachable or rigidly connected to the outside end of the L-shaped arm of utensil holder.
